(19) United States
(12) Patent Application Publication
(10) Pub. No.: US 2011/0186530 A1
(43) Pub. Date: Aug. 4, 2011

(54) Device Display Unit

(75) Inventor: James D. Karel, Bentonville, AR (US)

(73) Assignee: Wal-Mart Stores, Inc.

(21) Appl. No.: 13/085,249

(22) Filed: Apr. 12, 2011

Related U.S. Application Data
(63) Continuation of application No. 12/044,653, filed on Mar. 7, 2008.

(51) Int. Cl. A47F 7/00; E05B 73/00

(52) U.S. Cl. 211/4; 211/59.2; 211/26

(57) ABSTRACT

A display fixture for personal electronic devices. The personal electronic device display fixture comprises a base plate, a pillar and a display plate configured to display an MP3 player or other personal electronic device. The personal electronic device display fixture allows for the display of items associated with the personal electronic device and can be moved easily to various locations in a retail environment. The personal electronic device display fixture may also allow for the connection of an antitheft device to the merchandise.

### CROSS-REFERENCE TO RELATED APPLICATIONS

This application is a continuation of U.S. patent application Ser. No. 12/044,653, filed Mar. 7, 2008. The contents of this application are incorporated herein by reference in its entirety.

### FIELD OF THE INVENTION

The present invention relates generally to the field of merchandise display fixtures. More particularly, the invention relates to a fixture for the display of personal electronic devices in a retail environment.

### BACKGROUND OF THE INVENTION

This section is intended to provide a background or context to the invention that is recited in the claim. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Retailers often seek ways to display merchandise that will increase sales. Traditionally, retailers displayed merchandise in the merchandise packaging with associated items nearby the merchandise. While merchandise was displayed in its packaging, the merchandise was often displayed on shelves where items associated with the merchandise could easily be placed proximate the associated items. For example, retailers could place items such as headphones, batteries and carrying cases next to audio players on the same shelf.

As personal electronic devices have become smaller, retailers have sought new ways to display personal electronic devices outside of the merchandise packaging so that customers can evaluate the performance of the personal electronic devices. Therefore, display apparatuses have been developed that allow a retailer to display electronic merchandise free of the merchandise packaging.

### SUMMARY OF THE INVENTION

Various embodiments provide for an improved display fixture capable of displaying an MP3 player or other personal electronic device and items associated with the personal electronic device. The display fixture may comprise a base plate, a pillar and a display plate and is configured to display items associated with the personal electronic device. In various embodiments the display fixture may also allow for an anti-theft device to be operatively connected to the display fixture and the personal electronic device displayed.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of a display fixture according to an embodiment of the present invention;

FIG. 2 is a perspective view of a display fixture constructed according to an additional embodiment of the present invention;

FIG. 3 is a perspective view of a display fixture constructed according to a further embodiment of the present invention and including a mechanism for attaching a personal electronic device to the display fixture and an anti-theft device; and

FIG. 4 illustrates an example method for displaying a device and display fixture constructed according to various embodiments of the present invention.

### DETAILED DESCRIPTION OF VARIOUS EMBODIMENTS

Various embodiments provide for an improved display fixture capable of displaying an MP3 player or other personal electronic device and items associated with the personal electronic device. The display fixture may comprise a base plate, a pillar and a display plate and is configured to display items associated with the personal electronic device. In various embodiments the display fixture may also allow for an anti-theft device to be operatively connected to the display fixture and the personal electronic device displayed.

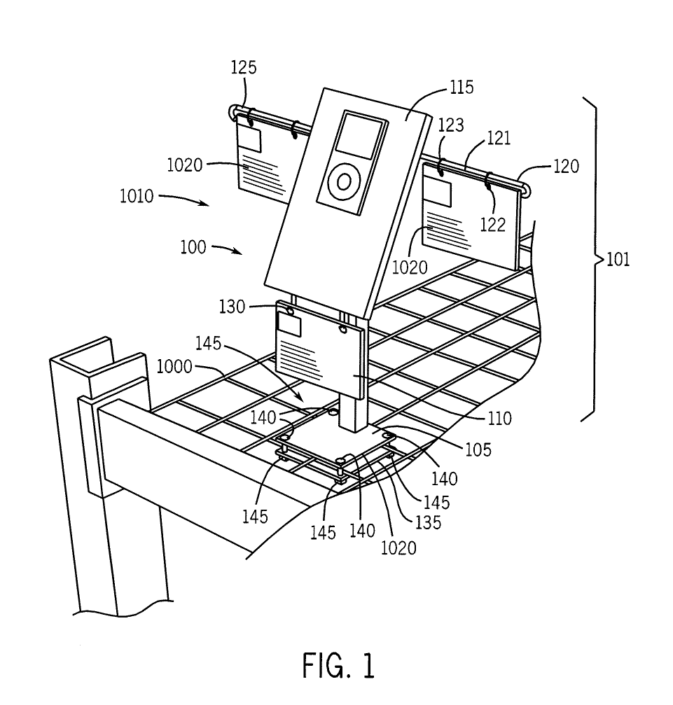

FIG. 1 is a perspective view of a display fixture, shown generally at 100, according to an embodiment of the present invention. The display fixture 100 is configured to display personal electronic devices such as MP3 players. Referring to FIG. 1, the display fixture is operatively connected to the top of a shelf 1000, such as a wire grid shelf. The display fixture 100 comprises a top base plate 105 and a pillar 110. A display plate 115 is operatively connected to the pillar 100 for displaying a personal electronic device 1010. The personal electronic device 1010 may be operatively connected to the display plate 115 so that the customer may evaluate the performance of the personal electronic device 1010 while the personal electronic device 1010 is outside its packaging. In the embodiment of FIG. 1, the display plate 115 is rigidly connected to the pillar 100. In other embodiments, the display plate 115 may be rotatably or otherwise movably coupled to the pillar 110.

The display fixture 100 of FIG. 1 also comprises a right display region 120, a left display region 125 and a front display region 130 protruding from the display plate 115. The right display region 120, the left display region 125 and the front display region 130 are configured to display associated items 1020. In the embodiment of FIG. 1, the right display region 120, the left display region 125 and the front display region 130 each comprise a hook. In greater detail, the right display region 120 includes an arm 121 that projects away from the display plate. A right hook 122 and a left hook 123 extend from the arm 121 and are configured to engage with an associated item 1020. In the embodiment of FIG. 1, the arm 121 projects substantially horizontal from the display plate 115. However, in other embodiments, the arm 121 need not project horizontally from the display plate 115.

In further embodiments, the right display region 120, the left display region 125 and the front display region 130 may extend from the pillar 110 or the top base plate 105. Additionally, the number of hooks extending from the display arm 121 may vary. In yet further embodiments, the right display region 120, the left display region 125 and the front display region 130 may comprise, for example, a shelf, Velcro, buttons, an adhesive strip, or other mechanisms for operatively connecting the associated items 1020 to the display fixture 100.

The display of associated items 1020 proximate the personal electronic device 1010 may increase sales of the personal electronic device 1010 and items associated with the personal electronic device 1010. In the case of an MP3 player, associated items 1020 may include, for example, gift cards for the purchase of music over the internet, headphones, headphone accessories, speakers, radio transmitters, audio output adapters, audio capture devices, cables, connectors, remote controls, radios configured to operate with the MP3 player, chargers, protective cases for the MP3 player, carrying cases for the MP3 player, docking stations for the MP3 player, docking station adapters, athletic products that function with the MP3 player, clothing items configured to accept the MP3 player, display screen protectors, display screen enhancers, cleaning products for the MP3 player, tools for repairing the MP3 player, replacement parts and other items whose sale or function may be linked to the MP3 player.

Together, the top base plate 105, the pillar 110, the display plate 115, the right display region 120, the left display region 125 and the front display region 130 comprise the upper portion 101 of the display fixture 100. This upper portion 101 is configured to operatively connect with a bottom base plate 135 that allows the display fixture to be connected to the shelf 1000. In the embodiment of FIG. 1, four bolts 140 and four nuts 145 connect the top base plate 105 to the bottom base plate 135 with the shelf 1000 between the top base plate 105 and the bottom base plate 135. This orientation secures the display fixture 100 to the shelf 1000 but also allows the display fixture 100 to be moved to another shelf in a retail environment. In other embodiments, the number of nuts 145 and bolts 140 may vary and need not be four. In additional embodiments, the display fixture 100 may not use nuts 145 and bolts 140 to operatively connect to the shelf 1000 and may instead be operatively connected using a clamp or other mechanism suitable for attaching the display fixture 100 to a shelf 1000.

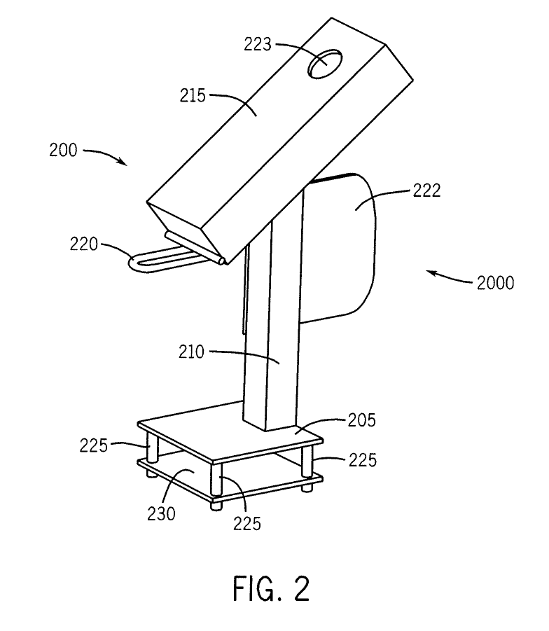

FIG. 2 shows an additional embodiment of a display fixture. The display fixture 200 comprises a top base plate 205 and a pillar 210. A display plate 215 is operatively connected to the pillar 210. A front display region 220 is located at the bottom of the display plate 215 on the front side of the display fixture 200. In the embodiment of FIG. 2, the front display region 220 comprises a hook. In other embodiments, the front display region 220 may protrude from the pillar 210 or the top base plate 205.

The embodiment of FIG. 2 is also configured to allow for the connection of an anti-theft device 2000 on an anti-theft device mounting region 222. In the embodiment of FIG. 2, the anti-theft device mounting region 222 comprises a plate operatively connected to the pillar 210. In other embodiments, the anti-theft device mounting region 222 may be located on the top base plate 205 or the display plate 215 and need not be a separate plate. To facilitate the connection of the device to be displayed with the anti-theft device 2000, the display plate 215 is configured to allow a connection on through an opening 223 in the display plate 215.

In a similar fashion to the embodiment of FIG. 1, the display fixture 200 of FIG. 2 can be connected to a fixed structure using bolts 225, a bottom base plate 230 and nuts configured to engage with the bolts 225. In the embodiment of FIG. 2, the bolts 225 are formed as protrusions of the top base plate 205.

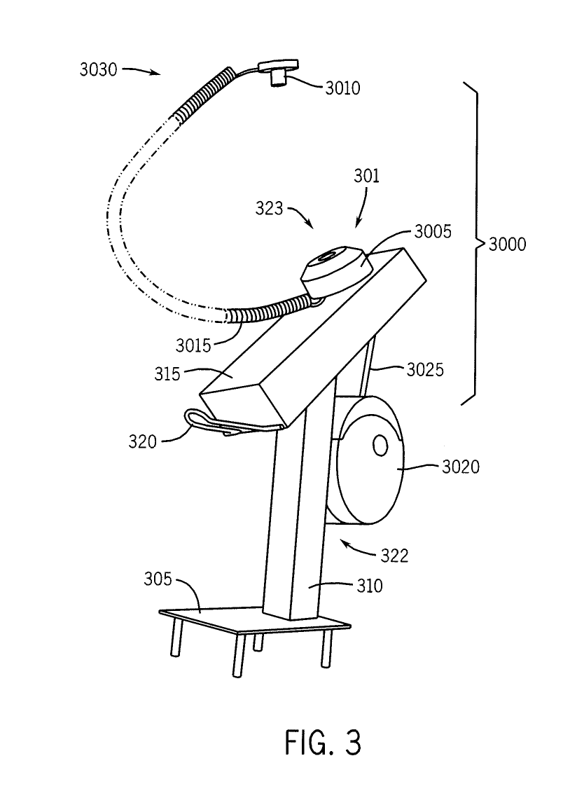

FIG. 3 is a perspective view of a display fixture, shown generally at 300, constructed according to a further embodiment of the present invention. The display fixture 300 comprises a top base plate 305, a pillar 310 and a display plate 315. The display fixture 300 also has a front display region 320 that comprises a hook in one embodiment. The display fixture is configured to accept the device to be displayed in a device attachment region 301.

In the embodiment of FIG. 3, an example anti-theft device, shown generally at 3000, is connected to the display fixture 300. The anti-theft device 3000 comprises a device mount receptor 3005 and a device mount 3010 which is configured to engage with the device mount receptor 3005. In the embodiment of FIG. 3, the device mount receptor 3005 is located in the device attachment region 301. A mount cable 3015 operatively connects the device mount 3010 to the device mount receptor 3005. An alarm 3020 is operatively connected to the display fixture 300 in an anti-theft device mounting region 322. An alarm cable 3025 operatively connects the device mount receptor 3005 to the alarm 3020.

A device 3030 may be operatively connected to the device mount 3010 using adhesive, screws, straps or other known mechanisms for connection. An opening 323, shown more clearly in the similar embodiment of FIG. 2 at 223, allows the alarm 3020 to operatively connect to the device mount receptor 3005 while concealing cords or cables which may clutter the visual appearance of the display fixture 300 and the device 3030 from sight.

In other embodiments, the type and configuration of the anti-theft device 3000 may vary and the configuration of the display fixture 300 may vary accordingly. For example, if the anti-theft device 3000 employs a retractable cable instead of the coiled mount cable 3015 in FIG. 3, additional associated item display regions may be included as the visual appeal of the display fixture 300 and the device 3030 may not be adversely affected by the potential of the coiled mount cable 3015 to become tangled with the associated item display regions.

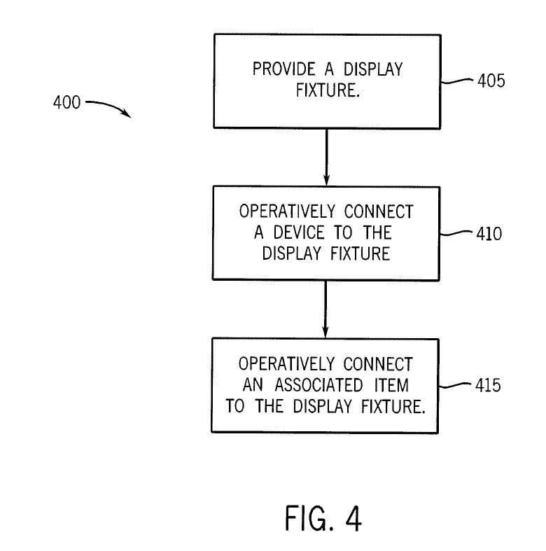

FIG. 4 illustrates an embodiment of a method, shown generally at 400, of displaying a personal electronic device using a display fixture constructed according to various embodiments of the present invention. At 405, a display fixture is provided. At 410, a device is operatively connected to the display fixture. At 415, an associated item is operatively connected to the display fixture.

The foregoing description of embodiments of the present invention has been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated.

What is claimed is:

1. A display fixture affixable to a shelf in a retail environment, comprising:
a top base plate configured for placement over an upper surface of the shelf;
a bottom base plate configured for placement entirely under a lower surface of the shelf and substantially opposing the top base plate, the bottom base plate selectively securable to the top base plate;
at least one connecting element selectively securable to the top base plate and the bottom base plate through the shelf, thereby affixing the display fixture to the shelf;
a pillar operatively connected to the top base plate; and
a display plate operatively and fixedly connected to the pillar, the display plate extending from the pillar in a rearwardly facing incline and defining an inclined product display;
wherein the display fixture is configured to define at least one associated item display region, the at least one associated item display region configured to display at least one item associated with a device to be displayed on the display fixture in the retail environment and wherein the display fixture is further configured to accept the device.

2. The display fixture of claim 1, wherein the at least one associated item display region comprises at least one hook.

3. The display fixture of claim 1, further comprising an anti-theft device mounting region configured to accept an anti-theft device.

4. The display fixture of claim 1, further comprising an anti-theft device operatively connected to the display fixture, wherein the anti-theft device is configured to operatively connect to a device to be displayed.

5. The display fixture of claim 1, further comprising:
an anti-theft device mounting region configured to accept an anti-theft device; and
an anti-theft device operatively connected to the display fixture in the anti-theft device mounting region, the anti-theft device including:
an alarm;
a device mount operatively connected to the alarm; and
a device mount receptor configured to engage with the device mount and operatively connected to the device mount.

6. The display fixture of claim 1, wherein the at least one item associated with the device to be displayed on the display fixture is selected from the group consisting of gift cards for the purchase of music over the internet, headphones, headphone accessories, speakers, radio transmitters, audio output adapters, audio capture devices, cables, connectors, remote controls, radios configured to operate with an MP3 player, chargers, protective cases, carrying cases, docking stations, docking station adapters, athletic products that function with an MP3 player, clothing items configured to accept an MP3 player, display screen protectors, display screen enhancers, cleaning products for an MP3 player, tools for repairing an MP3 player, and replacement parts.

7. The display fixture of claim 1, wherein the at least one associated item display region comprises an arm including at least one hook.

8. The display fixture of claim 1, wherein the at least one associated item display region comprises a horizontal arm projecting away from the display plate including:
a right display hook; and
a left display hook;
wherein the right display hook and left display hook are configured to connect to items associated with a device to be displayed.

9. The display fixture of claim 1, wherein the at least one associated item display region comprises two hooks projecting from the front of the display plate.

10. The display fixture of claim 1, wherein the at least one associated item display region comprises at least one hook configured to accept at least one card to be connected to the at least one hook.

11. The display fixture of claim 1, wherein the display fixture is further configured to operatively connect to a wire grid shelf.

12. The display fixture of claim 1, wherein the at least one connecting element comprises a plurality of bolts and nuts, the bolts and nuts configured to operatively engage each other to attach the display fixture to a shelf in a retail environment.

13. A method for displaying a device on a shelf in a retail environment, comprising:
providing a display fixture selectively affixable to the shelf, including:
a top base plate locatable on an upper surface of the shelf;
a bottom base plate locatable on a lower surface of the shelf, the bottom base plate substantially coextensive with and selectively securable to the top base plate;
at least one connecting element selectively engageable with the top base plate and the bottom base plate;
a pillar operatively connected to the top base plate; and
a display plate operatively connected to the pillar, the display plate extending in a rearward inclined orientation in relation to the pillar;
wherein the display fixture is configured to define at least one associated item display region, the at least one associated item display region configured to display at least one item associated with the device to be displayed on the display fixture in a retail environment including at least one shelf, and wherein the display fixture is further configured to accept a device;
associating the top base plate with an upper surface of the shelf;
associating the lower base plate with a lower surface of the shelf and locating the base plate substantially below and opposite the top base plate;
coupling the lower base plate to the upper base plate with the at least one connecting element;
operatively connecting a device to the display fixture; and
operatively connecting at least one associated item to the at least one associated item display region.

14. The method of claim 13, wherein the at least one associated item display region comprises at least one hook.

15. The method of claim 13, wherein the display fixture further comprises an anti-theft device mounting region configured to accept an anti-theft device.

16. The method of claim 13, further comprising:
operatively connecting an anti-theft device to the display fixture, the anti-theft device configured to connect a device to be displayed; and
operatively connecting the anti-theft device to the device to be displayed.

17. A display fixture, comprising:
a top base plate;
a pillar operatively connected to the top base plate and projecting substantially upward from the surface of the top base plate; and
an inclined display plate operatively connected to the pillar, the display plate rotatable in relation to the pillar about a substantially vertical axis, the display plate including:
a right associated item display region;
a left associated item display region; and
a front associated item display region;
wherein the right associated item display region, the left associated item display region and the front associated item display region are each configured to display items associated with the device displayed, and wherein the display fixture is configured to accept a device.

18. The display fixture of claim 17, wherein the right associated item display region, the left associated item display region, and the front associated item display region each comprise at least one hook.

19. The display fixture of claim 17, further comprising an anti-theft device mounting region configured to accept an anti-theft device.

20. The display fixture of claim 17, further comprising an anti-theft device operatively connected to the display fixture, wherein the anti-theft device is configured to operatively connect to a device to be displayed.
